(19) United States
(12) Patent Application Publication
(10) Pub. No.: US 2009/0182977 A1
(43) Pub. Date: Jul. 16, 2009

(54) CASCADED MEMORY ARRANGEMENT

(75) Inventor: G. R. Mohan Rao, McKinney, TX (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: S. AQUA SEMICONDUCTOR LLC, Wilmington, DE (US)

(21) Appl. No.: 12/015,393

(22) Filed: Jan. 16, 2008

(51) Int. Cl. G06F 12/00

(52) U.S. Cl. 711/209; 711/E12.059

(57) ABSTRACT

Embodiments of the present disclosure provide methods, apparatuses, and systems including a memory arrangement including a first memory, and a second memory operatively coupled to the first memory to serve as an external interface of the memory arrangement to one or more components external to the memory arrangement to access different portions of the first memory concurrently. Other embodiments may be described.

### TECHNICAL FIELD

Embodiments of the present disclosure relate to the field of integrated circuits, and, more specifically, to digital memory apparatuses and systems including a cascaded memory arrangement.

### BACKGROUND

Semiconductor memories play a vital role in many electronic systems. Their functions for data storage, code (instruction) storage, and data retrieval/access continue to span a wide variety of applications. Usage of these memories in both stand alone/discrete memory product forms, as well as embedded forms such as, for example, memory integrated with other functions like logic, in a module or monolithic integrated circuit, continues to grow. Cost, operating power, bandwidth, latency, ease of use, the ability to support broad applications, and nonvolatility are all desirable attributes in a wide range of applications.

In some memory systems, opening a page of memory may prevent access to another page of the memory bank. This may effectively increase access and cycle times. In multi-processor or multi-core systems, attempts to access memory in parallel while running different applications may compound the delays due to locked up memory banks.

Moreover, there may be risk of data incoherency in situations wherein the same data has been read and copied from a memory location by two or more processors or cores, and the data is subsequently modified by at least one processor or core. If the modified and most recently updated data is not available or made available, as the case may be, to all processors and/or cores, one or more of the processors or cores may be working on a stale copy of data.

### BRIEF DESCRIPTION OF THE DRAWINGS

Embodiments of the present disclosure will be readily understood by the following detailed description in conjunction with the accompanying drawings. Embodiments of the disclosure are illustrated by way of example and not by way of limitation in the figures of the accompanying drawings.

FIG. 1 illustrates a functional system block diagram including an exemplary memory arrangement in accordance with various embodiments of the present disclosure.

FIG. 2 illustrates an exemplary system including a memory arrangement in accordance with various embodiments.

FIG. 3 illustrates another exemplary system including a memory arrangement in accordance with various embodiments.

FIG. 4 illustrates a block diagram of a hardware design specification being compiled into GDS or GDSII data format in accordance with various embodiments.

### DETAILED DESCRIPTION OF EMBODIMENTS OF THE DISCLOSURE

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scope of embodiments in accordance with the present disclosure is defined by the appended claims and their equivalents.

Various operations may be described as multiple discrete operations in turn, in a manner that may be helpful in understanding embodiments of the present disclosure; however, the order of description should not be construed to imply that these operations are order dependent. Moreover, some embodiments may include more or fewer operations than may be described.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “access operation” may be used throughout the specification and claims and may refer to read, write, or other access operations to one or more memory devices.

Various embodiments of the present disclosure may include a memory arrangement including a first memory, and a second memory operatively coupled to the first memory to serve as an external interface of the memory arrangement to one or more components external to the memory arrangement to access different portions of the first memory concurrently. The concurrent access to different portions of the first memory may permit concurrent read/read, read/write, and write/write access operations, which may result in improved data coherency relative to various other systems.

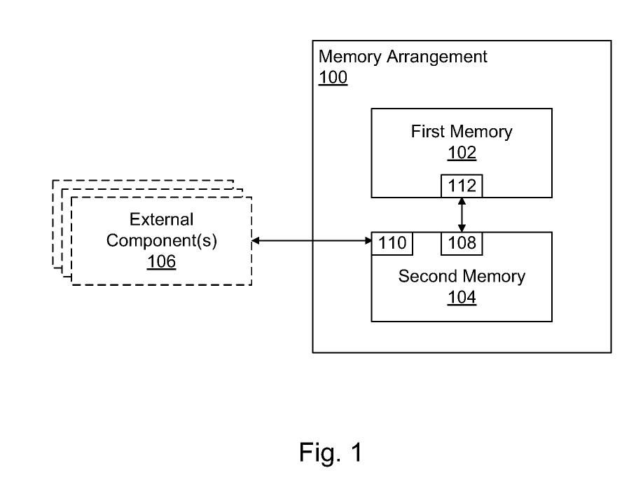

Referring to FIG. 1, illustrated is a block diagram of an exemplary memory arrangement 100 including a first memory 102 and a second memory 104 operatively coupled to first memory 102, in accordance with various embodiments of the present disclosure. Second memory 104 may be configured to serve as an external interface of memory arrangement 100 to one or more components 106 external to memory arrangement 100.

Second memory 102 may be configured to serve as an external interface of memory arrangement 100 to external component(s) 106 for accessing different portions of first memory 102 concurrently. In various ones of these embodiments, second memory 104 may be a dual-port memory including ports 108, 110, and first memory 102 may be single-ported including port 112. Port 108 of second memory 102 may be operatively coupled to port 112 of first memory 102. Port 110 of second memory 104 may be configured to operatively couple with one or more of external components 106.

Ports 108, 110 of second memory 104 may each be configured to permit read and write access operations. Accordingly, in various embodiments, a read or a write operation may be performed over port 108, while a read or a write operation is performed over port 110. This novel arrangement may advantageously allow concurrent access to different portions of first memory 102 for maintaining data coherency. For example, if data copied from first memory 102 into second memory 104 is modified, the modified data can be written back to first memory 102 over port 108, thereby updating the data, while at the same time second memory 104 may be accessed by external component(s) 106 over port 110 for another read or write operation. The write-back of modified data to first memory 102, then, may be performed with minimal delay.

First memory 102 and second memory 104 may comprise memory cells of any type suitable for the purpose. For example, first memory 102 and/or second memory 104 may comprise dynamic random access memory (DRAM) cells, or static random access memory (SRAM) cells, depending on the application. Further, while not illustrated, memory device 108 may include sense amplifier circuits, decoders, and/or logic circuitry, depending on the application.

First memory 102 and/or second memory 104 may be partitioned into memory units comprising some subset of memory such as, for example, a memory page or a memory bank, and each subset may comprise a plurality of memory cells (not illustrated). For example, in some embodiment, first memory 102 and/or second memory 104 may comprise a page type memory.

In various embodiments, different portions of first memory 102 of first memory 102 may be concurrently accessed. The different portions of first memory 102 may comprise disjoint subsets or may be intersecting/non-disjoint subsets of memory cells. In some embodiments wherein the different portions of first memory 102 are intersecting/non-disjoint subsets, the concurrent access operations may be limited to concurrent read operations to avoid conflicts such as, for example, data incoherence. On the other hand, in embodiments wherein the different portions of first memory 102 are disjoint subsets, various parallel access operations may be performed. For example, a read or a write operation may be performed on the first one or more memory cells while a read or a write operation is performed on the second one or more memory cells.

In various embodiments, first memory 102 may have a larger storage capacity relative to the storage capacity of second memory 104. Further, in various embodiments, first memory 102 may be a slower memory relative to second memory 102. First memory 102 may comprise, for example, relatively slow, large, high-density DRAM, SRAM, or pseudo-SRAM, while second memory 104 may comprise, for example, low-latency, high-bandwidth SRAM or DRAM. In some embodiments, for example, first memory 102 comprises DRAM while second memory 104 comprises SRAM. First memory 102 and/or second memory 104 may comprise any one or more of flash memory, phase change memory, carbon nanotube memory, magneto-resistive memory, and polymer memory, depending on the application.

It may be desirable in some embodiments, and as noted above, that second memory 104 comprise low-latency memory. Accordingly, in various embodiments, second memory 104 may have a random access latency that is significantly lower than that of first memory 102.

Moreover, in some embodiments, second memory 104 may comprise a memory having a read access time and a write access time that are nearly the same. Although it may be less important in some applications, first memory 102 may also comprise a memory having a read access time and a write access time that are nearly the same.

Memory arrangement 100 may comprise a discrete device or may comprise a system of elements, depending on the application. For example, in various embodiments, first memory 102 and second memory 104 may comprise a memory module. In various other embodiments, first memory 102 and second memory 104 may be co-located on a single integrated circuit.

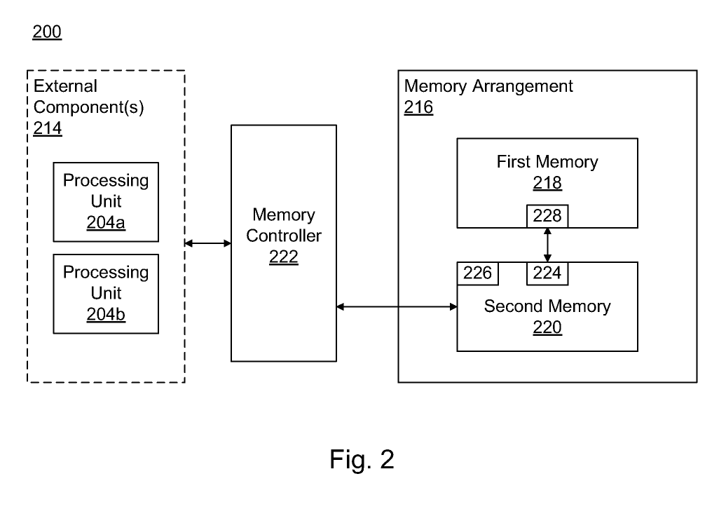

External component(s) 106 may comprise any one or more of various components generally requiring access to memory. As illustrated in FIG. 2, for example, an exemplary computing system 200 may comprise external component(s) 214 including one or more processing units 204a, 204b. Processing units 204a, 204b may comprise stand-alone processors or core processors disposed on a single integrated circuit, depending on the application.

System 200 may comprise a memory arrangement 216 such as, for example, memory arrangement 100 of FIG. 1. As illustrated, memory arrangement 216 includes first memory 218 and second memory 220. Memory arrangement 216 may be accessed by one or more of processing units 204a, 204b. In the embodiment illustrated in FIG. 2, two processors 204a, 204b are operatively coupled to memory arrangement 216 by way of memory controller 218. In various embodiments, however, more or fewer processing units may be coupled to memory arrangement 216.

In various embodiments, system 200 may include a memory controller 222 operatively coupled to memory arrangement 216 and external component(s) 214 for operating memory arrangement 216. In embodiments, memory controller 222 may be configured, for example, to issue read and write access commands to memory arrangement 216.

In some embodiments, each processing unit 204a, 204 with at least one core may include a memory controller integrated on the same IC. In other embodiments, several processing units 204a, 204, each with at least one core, may share a single memory controller. In alternative embodiments, memory arrangement 216 may include a controller (not illustrated), with some or all of the functions of memory controller 222 effectively implemented within memory arrangement 216. Such functions may be performed by use of a mode register within memory arrangement 216.

In various embodiments, when issuing access commands to memory arrangement 216, memory controller 222 may be configured to pipeline the addresses corresponding to the memory cells of memory arrangement 216 to be accessed. During address pipelining, memory controller 222 may continuously receive a sequence of row and column addresses, and then may map the row and column addresses to a particular bank or memory in a manner that avoids bank conflicts. In various ones of these embodiments, memory controller 222 may be configured to pipeline the addresses on rising edges and falling edges of an address strobe (or clock). Memory controller 222 may include a plurality of address line outputs over which the pipelined addresses may be delivered to memory arrangement 216.

As described herein, second memory 220 may be configured to serve as an external interface of memory arrangement 216 to external component(s) 214 for accessing different portions of first memory 218 concurrently. In various embodiments, memory controller 222 may be configured to facilitate the concurrent access. In various ones of these embodiments, second memory 220 may be a dual-port memory including ports 224, 226, and first memory 218 may be single-ported including port 228. Port 224 of second memory 220 may be operatively coupled to port 228 of first memory 218. Port 226 of second memory 220 may be configured to operatively couple for with one or more of external components 206, facilitated by memory controller 222.

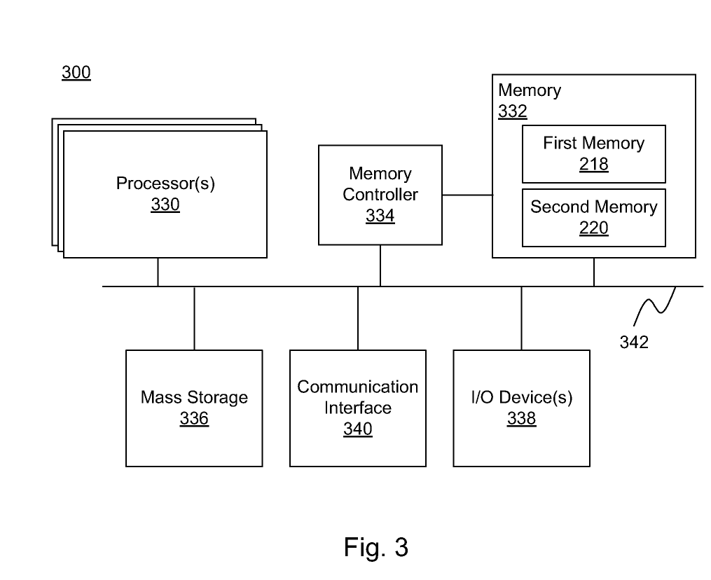

FIG. 3 illustrates an computing system 300 incorporating embodiments of the present disclosure. As illustrated, system 300 may include one or more processors 330, and system memory 332, such as, for example, memory arrangement 100 of FIG. 1 or memory arrangement 216 of FIG. 2.

Additionally, computing system 300 may include a memory controller 332 embodied with some or all of the teachings of the present disclosure for operating memory 332. Memory controller 332 may comprise a memory controller similar to memory control 222 of FIG. 2.

Moreover, computing system 300 may include mass storage devices 336 (such as, e.g., diskette, hard drive, CDROM, and the like), input/output devices 338 (such as, e.g., keyboard, cursor control, and the like), and communication interfaces 340 (such as, e.g., network interface cards, modems, and the like). The elements may be coupled to each other via system bus 342, which may represent one or more buses. In the case of multiple buses, they may be bridged by one or more bus bridges (not illustrated).

Other than the teachings of the various embodiments of the present disclosure, each of the elements of computing system 300 may perform its conventional functions known in the art. In particular, memory 332 and mass storage 336 may be employed to store a working copy and a permanent copy of programming instructions implementing one or more software applications.

Although FIG. 3 depicts a computing system, one of ordinary skill in the art will recognize that embodiments of the present disclosure may be practiced using other devices that utilize DRAM or other types of digital memory such as, but not limited to, mobile telephones, Personal Data Assistants (PDAs), gaming devices, high-definition television (HDTV) devices, appliances, networking devices, digital music players, digital media players, laptop computers, portable electronic devices, telephones, as well as other devices known in the art.

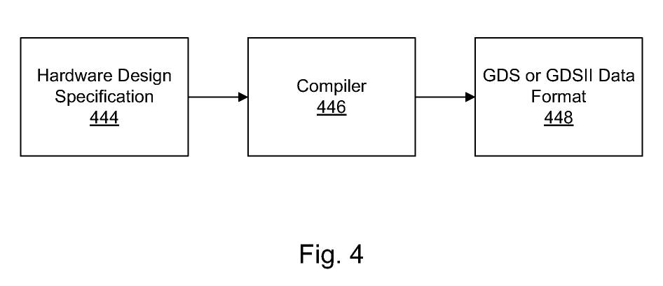

As noted herein, in various embodiments, a memory arrangement as described herein may be embodied in an integrated circuit. The integrated circuit may be described using any one of a number of hardware design language, such as but not limited to VHDL or Verilog. The complied design may be stored in any one of a number of data format such as, but not limited to, GDS or GDS II. The source and/or compiled design may be stored on any one of a number of media such as but not limited to DVD. FIG. 4 illustrates a block diagram depicting the compilation of a hardware design specification 444, which may be run through a compiler 446 to produce GDS or GDS II data format 448 describing an integrated circuit in accordance with various embodiments.

Although certain embodiments have been illustrated and described herein for purposes of description of a preferred embodiment, it will be appreciated by those of ordinary skill in the art that a wide variety of alternate and/or equivalent embodiments or implementations calculated to achieve the same purposes may be substituted for the embodiments shown and described without departing from the scope of the present disclosure. Those with skill in the art will readily appreciate that embodiments in accordance with the present disclosure may be implemented in a very wide variety of ways. This application is intended to cover any adaptations or variations of the embodiments discussed herein. Therefore, it is manifestly intended that embodiments in accordance with the present disclosure be limited only by the claims and the equivalents thereof.

1. A memory arrangement, comprising:
a first memory; and
a second memory operatively coupled to the first memory, wherein the second memory is configured to serve as an external interface for the memory arrangement to one or more components external to the memory arrangement and to facilitate concurrent access of different portions of the first memory.

2. The memory arrangement of claim 1, wherein the first memory comprises a first port and the second memory comprises a second port operatively coupled to the first port, and wherein the memory arrangement further comprises a third port configured to be operatively coupled with the one or more components external to the memory arrangement.

3. The memory arrangement of claim 1, wherein the first memory has a first storage capacity and the second memory has a second storage capacity substantially smaller than the first storage capacity.

4. The memory arrangement of claim 1, wherein the second memory has a read access time and a write access time, and wherein the write access time is nearly the same as the read access time.

5. The memory arrangement of claim 4, wherein the first memory has another read access time and another write access time, and wherein the other write access time is nearly the same as the other read access time.

6. The memory arrangement of claim 1, wherein the first memory is a page type memory.

7. The memory arrangement of claim 6, wherein the second memory is a page type memory.

8. The memory arrangement of claim 1, wherein the first memory has a first random access latency, and wherein the second memory has a second random access latency that is significantly lower than the first random access latency.

9. The memory arrangement of claim 1, wherein the memory arrangement is disposed on a single integrated circuit.

10. A system comprising:
a memory arrangement including a first memory, and a second memory operatively coupled to the first memory, wherein the second memory is configured to serve as an external interface of for the memory arrangement to one or more components external to the memory arrangement; and
a controller operatively coupled to the memory arrangement and configured to facilitate concurrent access to different portions of the first memory by the one or more components.

11. The system of claim 10, wherein the first memory comprises a first port and the second memory comprises a second port operatively coupled to the first port, and wherein the memory arrangement further comprises a third port configured to be operatively coupled with the one or more components external to the memory arrangement.

12. The system of claim 10, wherein the first memory has a first storage capacity, and the second memory has a second storage capacity substantially smaller than the first storage capacity.

13. The system of claim 10, wherein at least one of the first memory and the second memory has a read access time and a write access time, that wherein the write access time is nearly the same as the read access time.

14. The system of claim 10, wherein the first memory has a first random access latency, and wherein the second memory has a second access random access latency that is significantly lower than the first random access latency.

15. The system of claim 10, wherein at least one of the first memory and the second memory is a page type memory.

16. The system of claim 10, wherein the controller is configured to pipeline addresses to the memory arrangement.

17. The system of claim 16, wherein the controller is configured to pipeline the addresses on rising edges and falling edges of an address strobe.

18. The system of claim 10, wherein the one or more components comprise one or more processors.

19. The system of claim 10, wherein the one or more components comprise one or more processor cores disposed on a single integrated circuit.

20. The system of claim 10, wherein the system is disposed on a single integrated circuit.

21. A method of operating a memory arrangement having a first memory and a second memory operatively coupled to the first memory, the method comprising:
receiving, by the second memory from one or more components external to the memory arrangement, at least two access commands to access different portions of the first memory; and
concurrently accessing the different portions of the first memory in response to the at least two access commands.

22. The method of claim 21, wherein said concurrently accessing the different portions of the first memory comprises accessing a first one or more memory cells of a first subset from a plurality of memory cells for the first memory concurrently with accessing a second one or more memory cells of a second subset from the plurality of memory cells for the first memory, wherein the first and second subsets have no memory cells in common.

23. The method of claim 21, wherein said receiving comprises receiving addresses associated with the first memory on rising edges and falling edges of an address strobe.

24. An article of manufacture comprising a plurality of computer readable hardware design language or compilation of the hardware design language, the hardware design language specifying an implementation of the apparatus as set forth in claim 1 as an integrated circuit.

25. The article of manufacture of claim 24, wherein the hardware design language is either VHDL or Verilog.
